(19) United States
(12) Patent Application Publication
(10) Pub. No.: US 2009/0096231 A1
(43) Pub. Date: Apr. 16, 2009

(54) COLLAPSIBLE WORKBASKET ASSEMBLY

(76) Inventor: Michael J. Burlingame, East Liverpool, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/870,878

(22) Filed: Oct. 11, 2007

(51) Int. Cl. B66F 13/00

(52) U.S. Cl. 294/68.3

(57) ABSTRACT

A workbasket assembly for surrounding and protecting a workman when cleaning or maintaining a tall structure such as a building, tank or silo. The workbasket assembly comprises a frame made up from a plurality of vertical uprights and horizontal rails connected together by a plurality of pivot tabs. The workbasket assembly may be collapsed for storage or transport purposes or so that it may be passed through a relatively small aperture in a structure such as a tank. When expanded, the workbasket assembly is engageable with a hoist-operable base that permits the workman to be safely raised or lowered relative to the structure being maintained. The frame is only movable to the fully collapsed condition when detached from the base. The workbasket assembly can be expanded and collapsed without the use of any tools.

### BACKGROUND OF THE INVENTION

1. Technical Field

This invention generally relates to support structures. More particularly, the invention relates to a workbasket that is useful for cleaning the interiors or exteriors of large structures such as water towers, silos and buildings. Specifically, the invention relates to a workbasket assembly that is attachable to a hoist-operable base and is easily moved between a collapsed and an expanded condition without the use of tools.

2. Background Information

Large tanks are used in a wide variety of industries and operations to both store and process goods. Water towers, for example, are used to store large quantities of water for later use. Similarly, silos are used to store a wide variety of materials including grains, fermented feed, coal, cement and other bulk materials. In the power industry, boilers are used to superheat steam for the generation of electricity. The tanks utilized in these industries are tall structures that typically have relatively small access ports through which the water or other materials are introduced or removed from the structure. In silos, for example, the materials to be stored may be introduced into an access port near the top of the silo and removed from another port near the bottom of the silo. Periodically, the silo may require cleaning because the materials stored therein become compacted at the base of the silo, a condition known as bridging, or cling to the interior surfaces of the silo's side walls, a condition known as rat holing. In both instances, the flow of material from the silo is impeded and the only solution is to clean the interior of the silo. Similarly, water towers, boilers and other structures such as tall buildings periodically need to be cleaned or maintained.

The interiors of large tanks are cleaned through a variety of means, one of which is manual cleaning. This requires that a workman enter the interior of the tank and be raised and lowered in a workbasket that is attached to a hoist via a steel or wire cable. The cleaning operation may be complicated by the fact that the workman, the workbasket and all the workman's equipment have to be introduced into the tank through a very small opening near the tank's base. In the case of power plant boilers, for example, these openings may only be around 18″×18″, 10″×17″ or 12″×18″ in size. The workman can enter such a size opening reasonably easily, but if a workbasket is to be used, moving the workbasket into the interior has proven to be problematic. In the past, the various components that make up the workbasket have been individually passed through the opening and into the interior of the tank. The entire workbasket has then had to be assembled within the confines of the tank's interior. After performing the cleaning or maintenance operation, the workman has had to disassemble the workbasket and pass the individual components back out through the opening. This is obviously a time consuming and labor intensive operation.

There is therefore a need in the art for an improved workbasket for use in cleaning and maintenance of tall structures such as tanks and buildings.

### SUMMARY OF THE INVENTION

The device of the present invention comprises a workbasket assembly for surrounding and protecting a workman when cleaning or maintaining a tall structure such as a building, tank or silo. The workbasket assembly comprises a frame made up from a plurality of vertical uprights and horizontal rails connected together by a plurality of pivot tabs. The workbasket assembly may be collapsed for storage or transport purposes or so that it may be passed through a relatively small aperture in a structure such as a tank. When expanded, the workbasket assembly is engageable with a hoist-operable base that permits the workman to be safely raised or lowered relative to the structure being maintained. The frame is only movable to the fully collapsed condition when detached from the base. The workbasket assembly can be expanded and collapsed without the use of any tools.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a workbasket in accordance with the present invention and showing the base and collapsible workbasket assembly engaged together;

FIG. 2 is a perspective view of the collapsible workbasket assembly in accordance with the present invention shown detached from the workbasket and in an expanded condition;

FIG. 3 is a partial cross-sectional bottom view of a gate rail on the workbasket assembly taken through line 3-3 of FIG. 2;

FIG. 4 is a partial cross-sectional side view of the gate rail taken through line 4-4 of FIG. 3;

FIG. 5 is a cross-sectional bottom view of the pivotal connection between the gate rail and upright taken through line 5-5 of FIG. 4;

FIG. 6 is a right side view of the bottom rail of the workbasket assembly taken through line 6-6 of FIG. 2;

FIG. 7 is a perspective view of the base of the workbasket with the collapsible workbasket assembly removed therefrom;

FIG. 8 is a front view of the workbasket assembly showing the first stage of collapsing the same;

FIG. 9 is a front view of the workbasket assembly showing the second stage of collapsing the same;

FIG. 10 is a front view of the workbasket assembly showing the assembly in a partially collapsed condition;

FIG. 11 is a top view of the workbasket assembly in the partially collapsed condition and taken through line 11-11 of FIG. 10;

FIG. 12 is a top view of the partially collapsed workbasket assembly shown in the third stage of collapsing the same;

FIG. 13 is a rear view of the workbasket assembly shown in a fully collapsed condition; and

FIG. 14 is a perspective view of a second embodiment of a collapsible workbasket assembly in accordance with the present invention and showing the inclusion of roller bumpers therein.

### DETAILED DESCRIPTION OF THE INVENTION

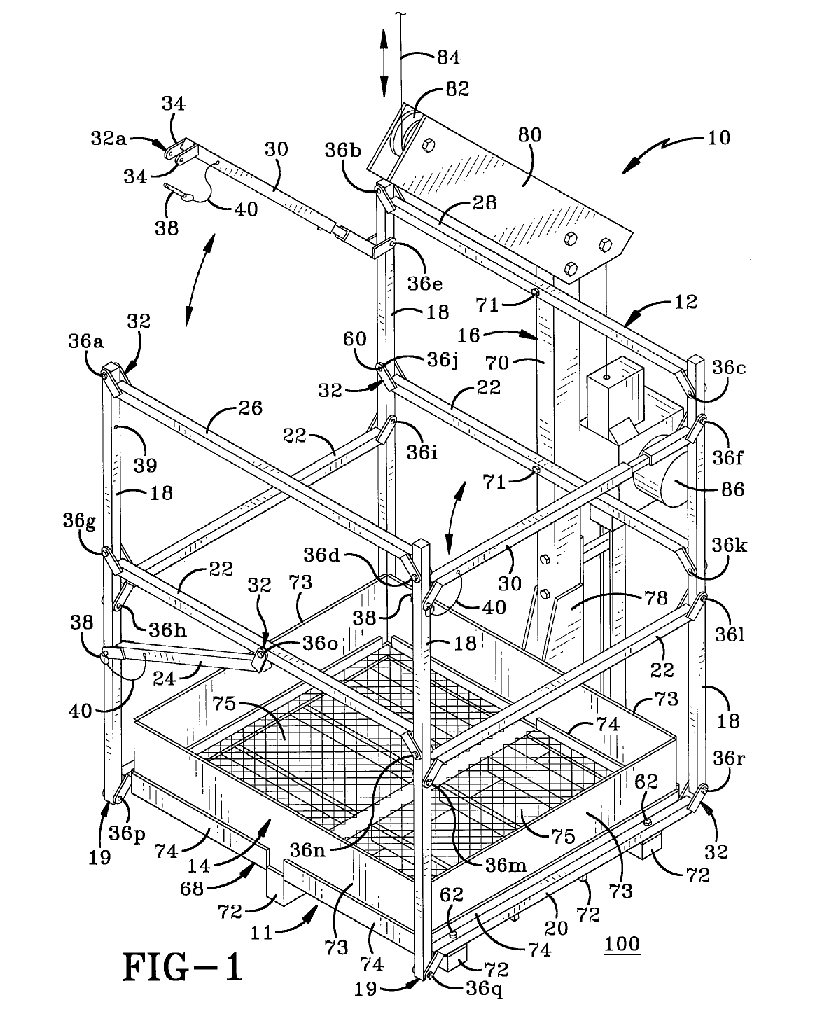

Referring to FIGS. 1-8 there is shown a workbasket in accordance with the present invention and generally indicated at 10. Workbasket 10 comprises a base 11 and a collapsible workbasket assembly 12 that are detachably engageable with each other. Base 11 comprises a floor frame 14 and a mast assembly 16 that extend upwardly away therefrom. The mast assembly 16 is adapted to be engaged with a hoist (not shown) to raise and lower workbasket 10 relative to a horizontal surface 100 such as a bottom wall of a tank (not shown).

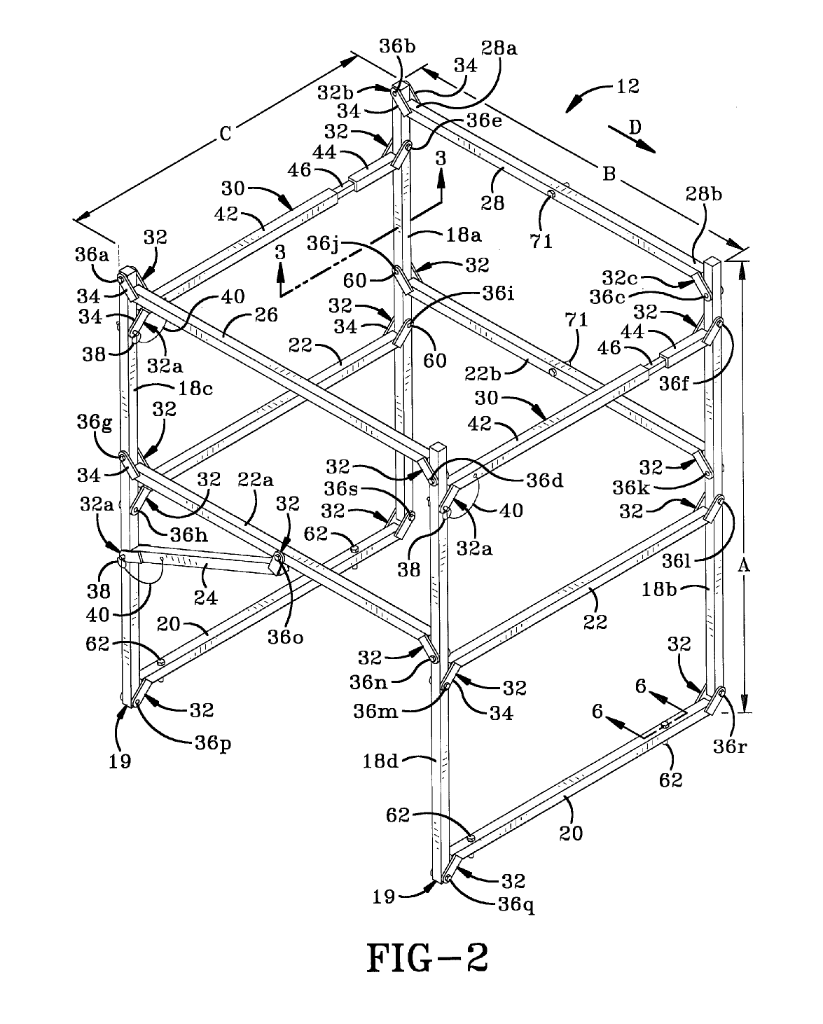

Workbasket assembly 12 is shown separated from workbasket 10 in FIG. 2. Workbasket assembly 12 comprises a foldable frame made up from four uprights 18, two base rails 20, four mid-rails 22, a stabilizer bar 24, a front rail 26, a back rail 28 and two gate rails 30. As shown in FIG. 8, back rail 28 is positioned vertically further away from the bottom end 19 of uprights 18 than is front rail 26. Furthermore, the back mid-rail 22b is positioned further from bottom end 19 than is front mid-rail 22a. This difference in relative distances from bottom end 19 enables workbasket assembly 12 to be more easily collapsed than would be the case if all of the rails were at comparable distances from bottom end 19.

Each of the rails 20, 22, 26, 28 and 30 is connected to two of the uprights 18. The connections are made by way of pivot tabs 32. All of the pivot tabs 32, except for tabs 32a on gate rails 30, comprise a pair of spaced apart flanges 34 that are welded at one end to one of the rail and are connected at the other end by way of a pivot pin 36 to the associated upright. So, for example, back rail 28 is secured between uprights 18a, 18b (FIG. 2) by pivot tabs 32b, 32c. Pivot pin tab 32b is welded onto first end 28a of back rail 28 so that it extends upwardly therefrom. Pivot tab 32b is pivotally secured to upright 18a by pivot pin 36b. Pivot tab 32c is welded onto second end 28b of back rail 28 so that it extends downwardly therefrom. Pivot tab 32c is pivotally connected to upright 18b by pivot pin 36c. Furthermore, pivot tabs 32b and 32c extend outwardly from back rail 28 substantially parallel to each other. This type of connection arrangement is true of each rail in workbasket assembly 12. The ends of flanges 34 that are welded are those ends that are secured to the rails. The ends of the flanges 34 that are pivotally secured are those that are pivotally secured to uprights 18 by pivot pins 36. This connection arrangement permits only a defined range of pivotal motion by the uprights 18 and rails, 20, 22, 26, 28 and 30. When workbasket assembly 12 is moved in a first direction to collapse the structure, some of the plurality of flanges 34 are brought into contact with some of uprights 18. For example, back rail 28 can be moved in a direction “D” (FIG. 2). This movement causes uprights 18a, 18b to pivot about pivot pins 36b, 36c and workbasket assembly 12 begins to collapse in the direction “D”. If, however, an attempt was made to move back rail 28 in a direction opposite to direction “D”, then first end 28a of back rail 28 would come into abutting contact with upright 18a and motion in that direction will cease. This is true of all of the rails in workbasket assembly 12 and, as a consequence, workbasket assembly 12 can only be moved from an expanded condition (FIG. 2) to at least a partially collapsed condition (FIG. 10) in a single direction, i.e., direction “D”. Workbasket assembly 12 can also be moved from that collapsed condition (FIG. 10) to an expanded condition (FIG. 2) in only a single direction, i.e., the opposite direction to “D”.

A first end of each gate rail 30 is secured to one of uprights 18a or 18b by pivot tabs 32. A second end of each gate rail 30 is secured to uprights 18c or 18d by pivot tabs 32a. Pivot tabs 32 each comprise a pair of spaced apart flanges 34 but, instead of a pivot pin 36, the securement used is a detented ring pin 38 and lanyard 40. Similarly, as shown in FIG. 2, one end of stabilizer bar 24 is secured to mid-rail 22a by a pivot tab 32 and a second end of stabilizer bar 24 is secured to upright 18c by a pivot tab 32a and a detented ring pin 38 and lanyard 40. Thus, one end of each of gate rails 30 and stabilizer bar 24 may be released from engagement with an upright 18 and pivoted as shown by the arrows in FIGS. 1 and 8 respectively.

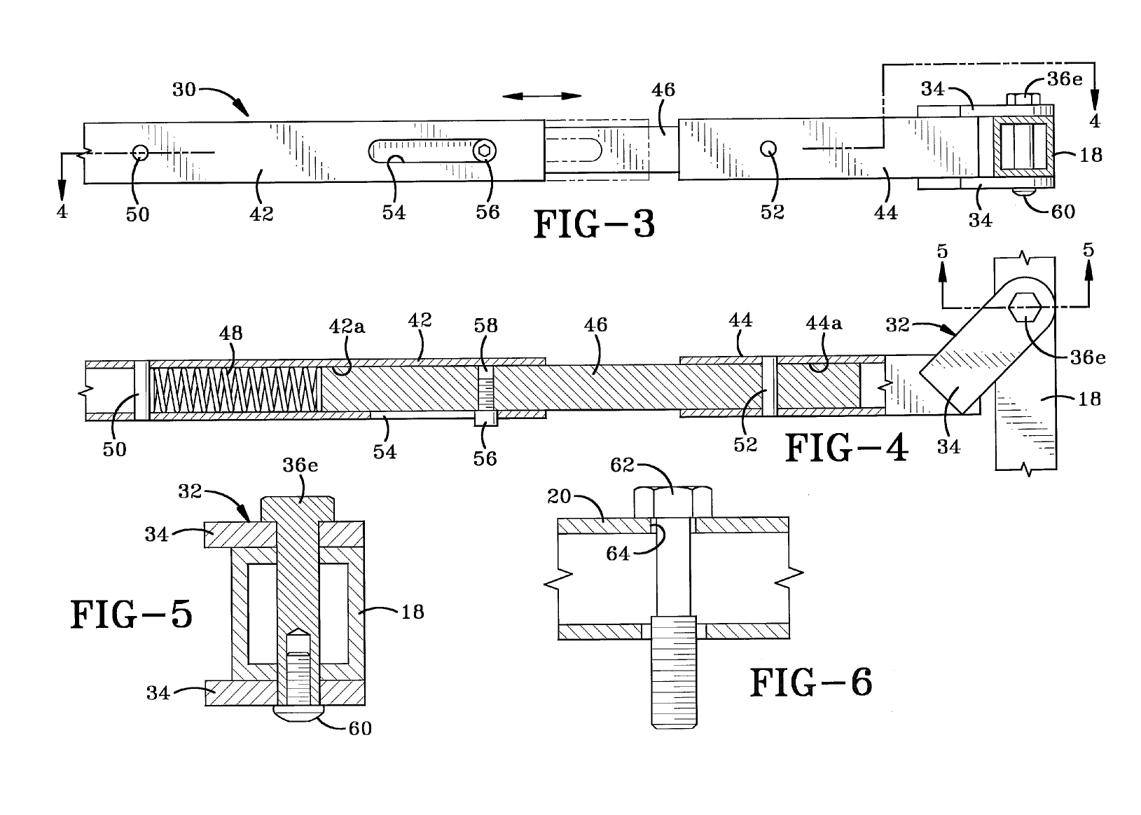

Gate rails 30 are shown in greater detail in FIGS. 3 & 4. Each gate rail 30 comprises a tubular first sleeve 42 and second sleeve 44. First and second sleeves 42, 44 each include a bore 42a, 44a that receives a portion of a bar 46 therein. A compression spring 48 is received within bore 42a between a roll pin 50 and bar 46. The opposite end of bar 46 is secured within bore 44a by a second roll pin 52. First sleeve 42 is also provided with a slot 54. A cap screw 56 is secured within an aperture 58 in bar 46. The head of screw 56 extends through slot 54. First sleeve 42 is slidable along bar 46 as indicated by the arrow in FIG. 3. Screw 56 limits the degree of travel of first sleeve 42 along bar 46. First sleeve 42 is retractable toward second sleeve 44 when gate rail 30 is to be detached from upright 18c and is movable toward upright 18c when gate rail 30 is to be reconnected thereto. It will be understood by those skilled in the art that a single sleeve may be provided to engage with the bar 46. In this latter instance, one end of first sleeve 42 would be pivotally and detachably connected to upright 18c and a free end of bar 46 could be directed and fixedly secured to upright 18a, without departing from the spirit of the present invention.

FIG. 3 and 5 also illustrate a portion of the pivotal connection between upright 18 and gate rail 30 in greater detail. Flanges 34 of pivot tab 32 is welded onto the exterior surface of second sleeve 44 and a second end of flanges 38 are secured to each other and to upright 18 by pivot pin 36 and a cap screw 60. This pivotal connection is illustrative of the connection between all pivot tabs 32 and uprights 18 in workbasket assembly 12.

Referring to FIG. 6, base rails 20 are each provided with a pair of spaced apart captive hex screws 62 that are received through apertures 64 in base rails 20.

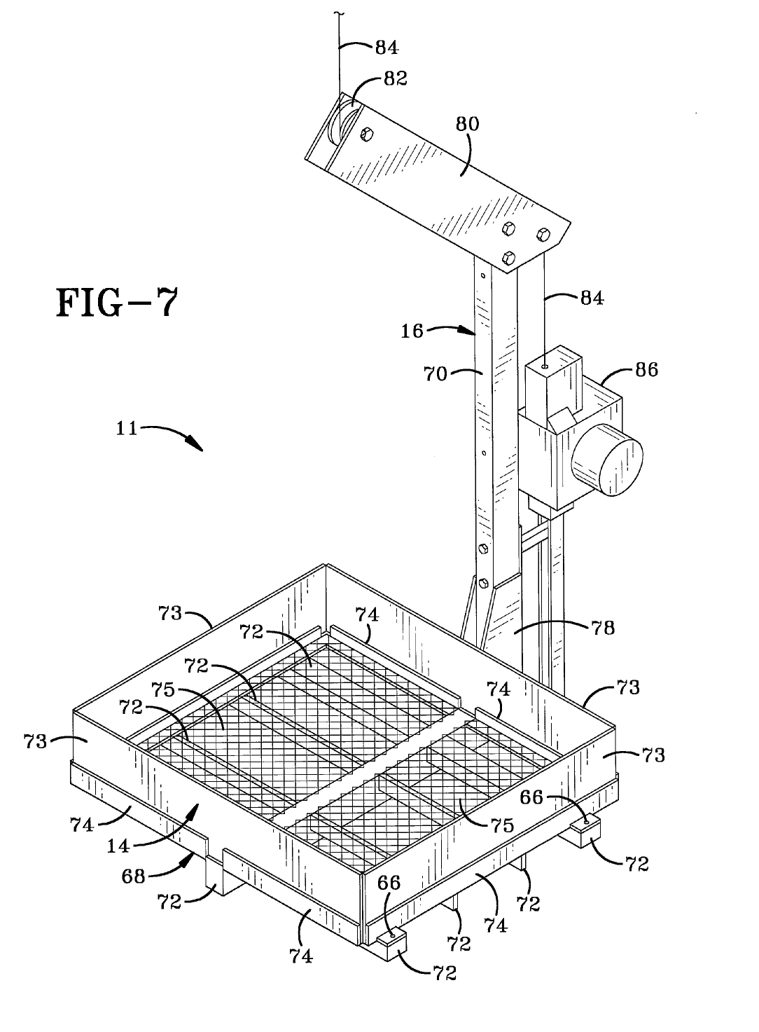

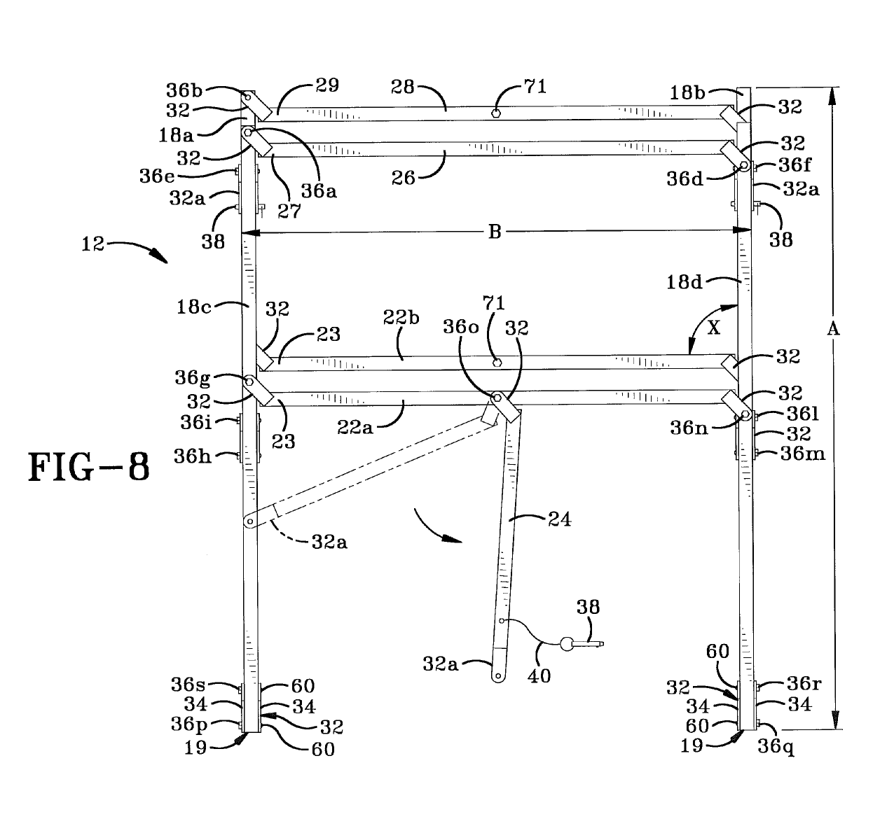

FIG. 7 shows the base 11, including floor frame 14 and mast 16, in greater detail. Mast assembly 16 comprises a base 68 and a mast 70 that extend vertically upwardly from said base 68. A plurality of connectors 71 are used to secure back rail 28 and mid rail 22 to mast 16. Base 68 has a plurality of spaced-apart supports 72 and an upstanding lip 74 that together define a cradle for receiving floor frame 14 therein. Apertures 66 are provided in the ends of two of supports 72. Floor frame 14 has a rim 73 sized to be received within the cradle of base 68. One or more steel angle and mesh sheets 75 are received within rim 73 to provide a solid surface to support a workman thereon. Workbasket assembly 12 is engaged with floor frame 14 and mast assembly 16. When workbasket assembly 12 is in an expanded condition (shown in FIG. 2), base rails 20 rest on the ends of supports 72 and hex screws 62 are received within apertures 66 in supports 72. Uprights 18 of workbasket assembly 12 are positioned outwardly away from the corners of rim 73 of floor frame 14. While floor frame 14 is shown as two separate sheets 75 that rest on frame 14, it should be understood that frame 14 and sheet 75 could be hinged and foldable so that they too may be passed through a smaller access port of a tank or any other small confined space.

Still referring to FIG. 7, mast assembly 16 further includes support angles 78, 80 at either end of mast 70. A guide roller assembly 82 is mounted onto support angle 80 and a steel cable 84 wraps around roller assembly 82 and is fed therethrough to motor 86. Mast assembly 16 is used to connect workbasket 10 to a hoist (not shown) which is then used to raise or lower workbasket 10 relative to a horizontal surface 100 such as the interior bottom wall of a tank.

In accordance with a specific feature of the present invention, workbasket assembly 12 is movable between an expanded and a collapsed condition as hereinafter described. In the expanded condition (shown in FIG. 2), assembly 12 has a height “A” of around 45 inches, a length “B” of around 37 inches and a width “C” of around 33 inches.

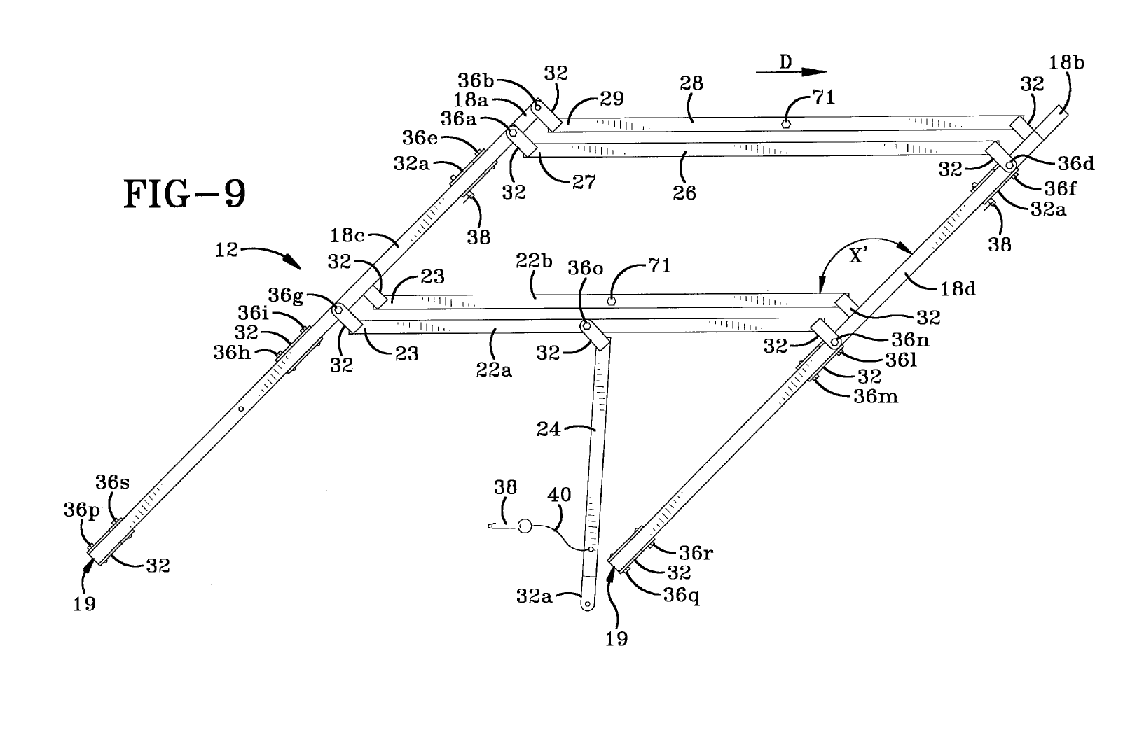

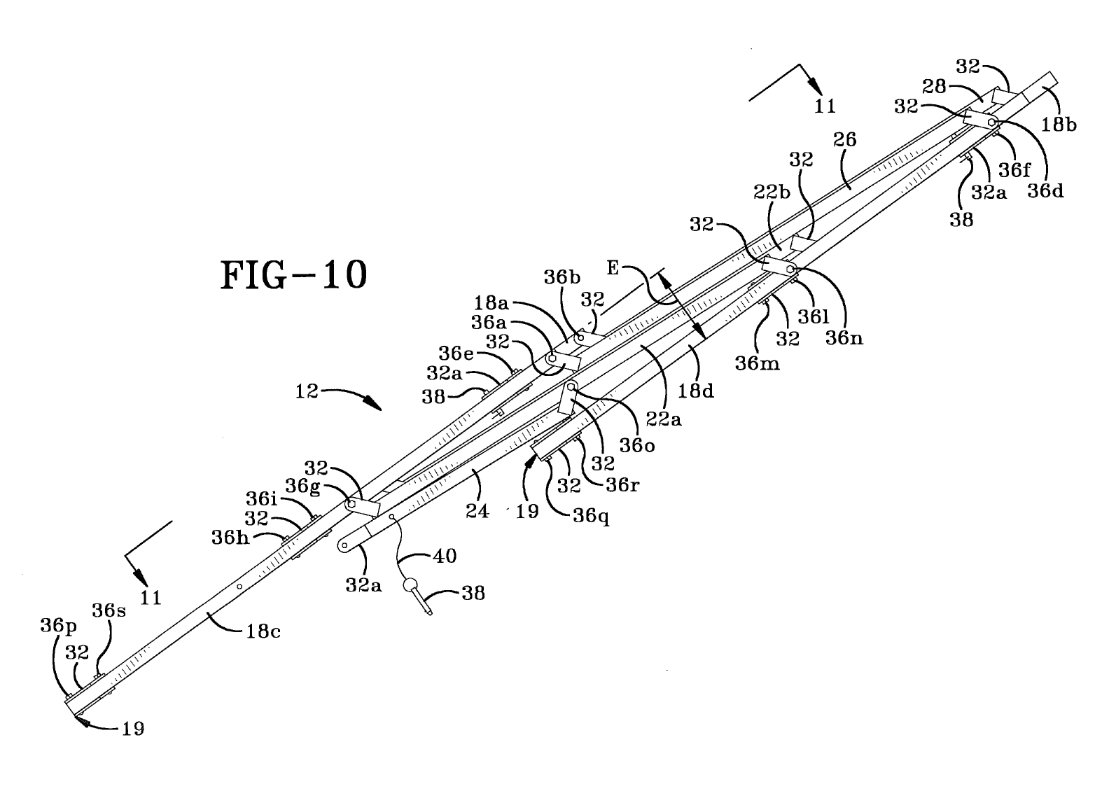

The procedure for collapsing workbasket assembly 12 is shown in FIGS. 8-13. The procedure is described as though the workman is standing in front of front rail 26 facing assembly 12. Firstly, stabilizer bar 24 is detached from upright 18c by removing ring pin 38 from the associated pivot tab 32a. Stabilizer bar 24 pivots about pivot pin 360 and hangs freely from mid-rail 22a. The workman grasps one of the rails, such as front rail 26, and gently moves front rail 26 toward the right as indicated by arrow “D” in FIG. 9. This movement causes uprights 18a, 18b, 18c and 18d to pivot about pivot pins 36a, 36d, back rail 28 to pivot about pivot pins 36a, 36b, 36c, 36d, 36g, 35j, 36k and 36n. The motion causes the angle X (FIG. 8) between uprights 18a-18d and front rail 26, back rail 28, mid-rail 22a and mid-rail 22b to be changed from being substantially at right angles thereto to an angle X′ (FIG. 9) of greater than ninety degrees. The pivoting motion causes workbasket assembly 12 to begin to fold, thereby reducing the overall height thereof. The movement of front rail 26 toward the right is continued until workbasket assembly 12 is collapsed into the shape shown in FIG. 10. In FIG. 10, workbasket assembly 12 is partially collapsed and has a height “E”. This is the shortest vertical height that assembly 12 can have. In the preferred embodiment of the invention, height “E” is around 6 inches.

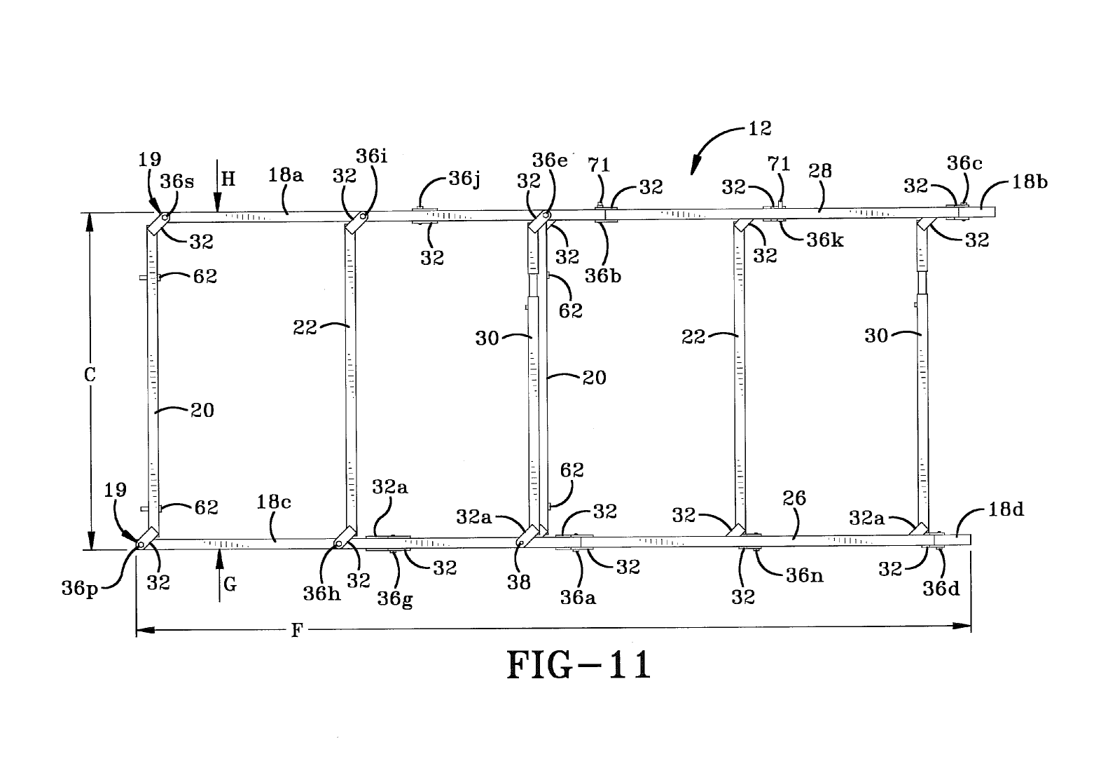

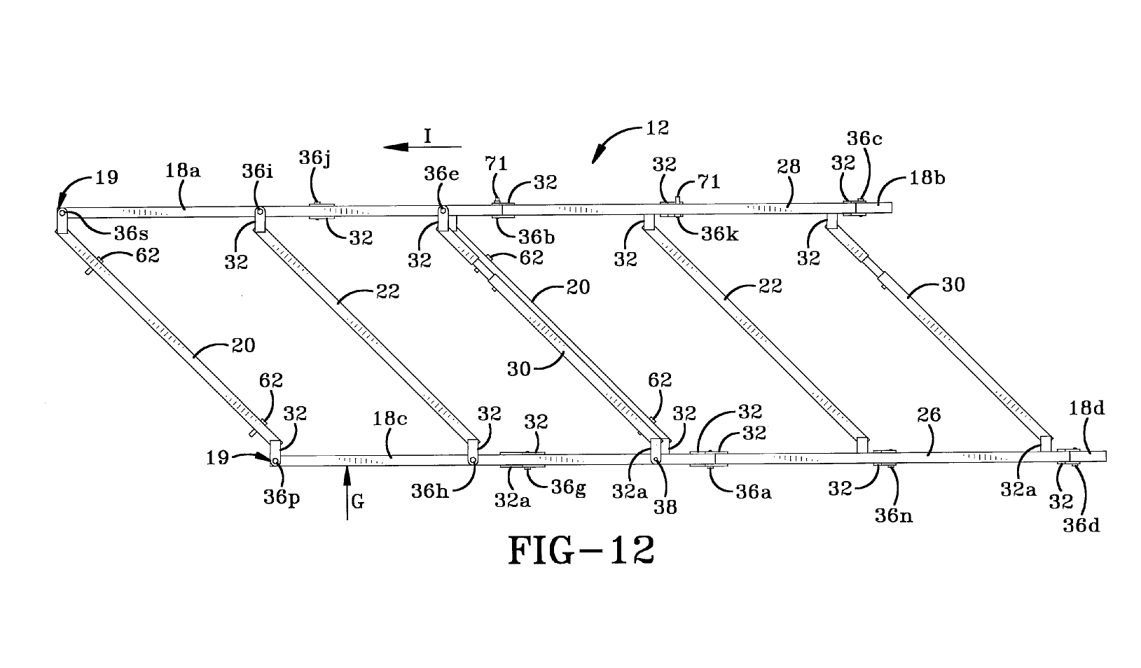

FIG. 11 shows a top view of the partially collapsed workbasket. At this stage, while the total height of the workbasket is height “E”, the width of assembly 12 remains the width “C”, i.e., 33 inches. The overall length of workbasket assembly 12 is length “F” which is around 84 inches.

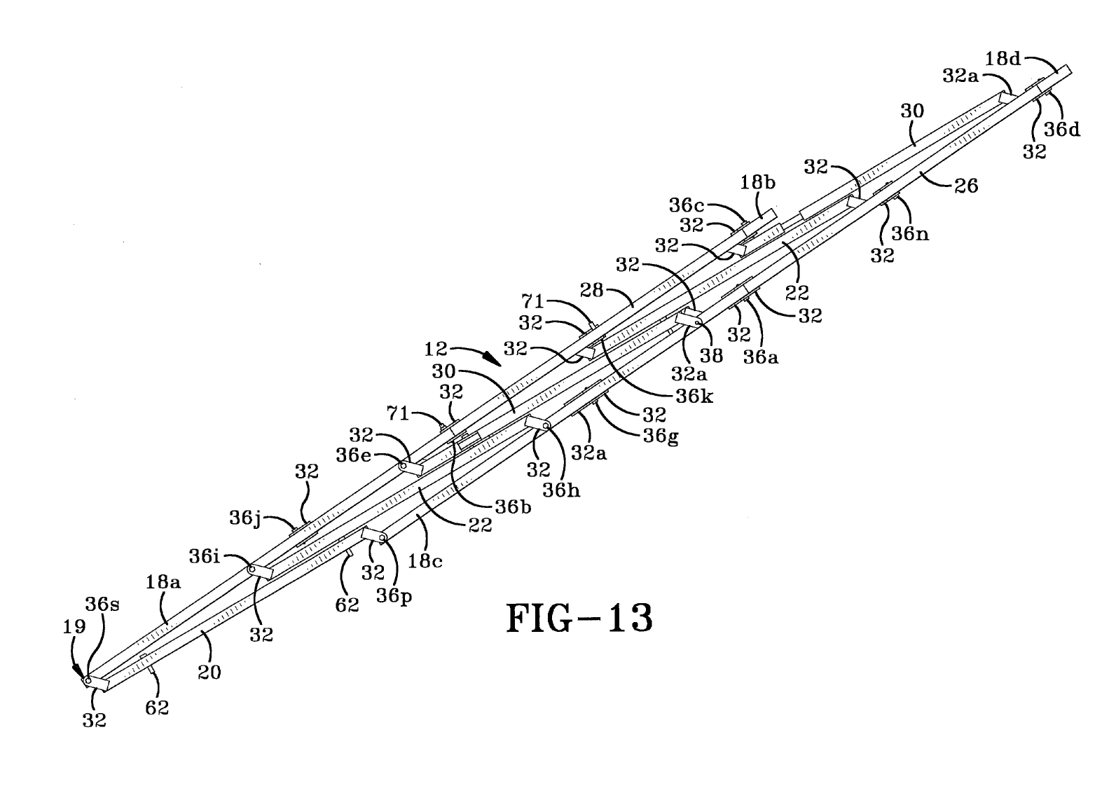

The workman then stands workbasket assembly on either one of the two edges “G” or “H”. FIG. 12 shows workbasket assembly 12 resting on edge “G”. The workman then grasps back rail 28 or upright 18a and moves the same in the direction of arrow “I”. This movement causes upright 18a, back rail 28, upright 18c and front rail 26 to pivot about pivot pins 36s, 36p, 36i, 36h, 36e, 38, 36l, 36m, 36c and 36d. There is also motion about the pivot pins that connect the other of bottom rails 20 (not shown) to uprights 18b, 18d, but these pivot pins cannot be seen in FIG. 12. The motion of workbasket assembly 12 in the direction of arrow “I” causes workbasket assembly 12 to become smaller than width “C”. The workman continues to move rail 28 in the direction of arrow “I” until workbasket assembly 12 has the appearance shown in FIG. 13. This is the fully collapsed condition and in this state, workbasket assembly 12 has a length of 114 inches, a height of 6-7 inches and a width of 6-7 inches. Workbasket assembly 12 can now be slid through a narrow opening, even an opening that is about 8×8 inches in size.

When the workbasket assembly 12 is in the desired location, it may be unfolded by reversing the above-mentioned steps until assembly 12 is once again in the fully expanded condition (FIG. 2). Assembly 12 is then positioned over floor assembly 14 and fasteners 62 are engaged in supports 72. Workbasket 10 can then be attached to a hoist (not shown) via mast 70. When a workman wishes to enter workbasket 10, they may release either one of gate rails 30. This is done by removing ring pin 38 from the aperture 39 in the appropriate one of vertical rails 18c or 18d. This detaches pivot tab 32a from the vertical rail 18c or 18d. The workman then slides first sleeve 42 rearwardly toward second sleeve 44, thereby effectively reducing the overall length of gate rail 30. Gate rail 30 is then rotated upwardly away from mid-rail 22 as shown by the arrow in FIG. 1. The workman may then step more easily over mid-rail 22 and onto the grate in floor assembly 14. Gate rail 30 is rotated downwardly and first sleeve 42 is slidably moved away from second sleeve 44 to increase the length of rail 30. Pivot tab 32a is then repositioned proximate aperture 39 and ring pin 38 is inserted through aligned holes in the pivot tab 32a and aperture 39. When the workman wants to exit workbasket 10, he releases gate rail 30 once again, rotates the same out of the way, steps out of workbasket 10 and reattached gate rail 30 to the appropriate one of vertical rails 18c, 18d.

It should be noted that the pivot tabs 32, 32a are shaped and arranged on workbasket assembly 12 in such a manner that assembly 12 can only be moved from the expanded condition to the partially collapsed condition by moving front rail 26 in only one single direction. So, for example, in FIGS. 8 and 9, front rail 26 of workbasket assembly 12 can only be moved toward the right, i.e., in the direction of arrow “D” in order to collapse the basket. If front rail 26 was moved in the direction opposite to arrow “D” the edges 27, 29 of front and back rails 26, 28 and edges 23 of mid-rails 22 would hit into uprights 18a and 18c and stop all movement in that direction. This arrangement simplifies matters for the workman because he doesn't have to stop and think about how to collapse or expand workbasket assembly 12. Furthermore, the interference of the edges 27, 29 and 23 with uprights 18a, 18c also stops workbasket assembly 12 from collapsing in the direction opposite to arrow “D” when the workman is attaching or detaching stabilizer bar 24.

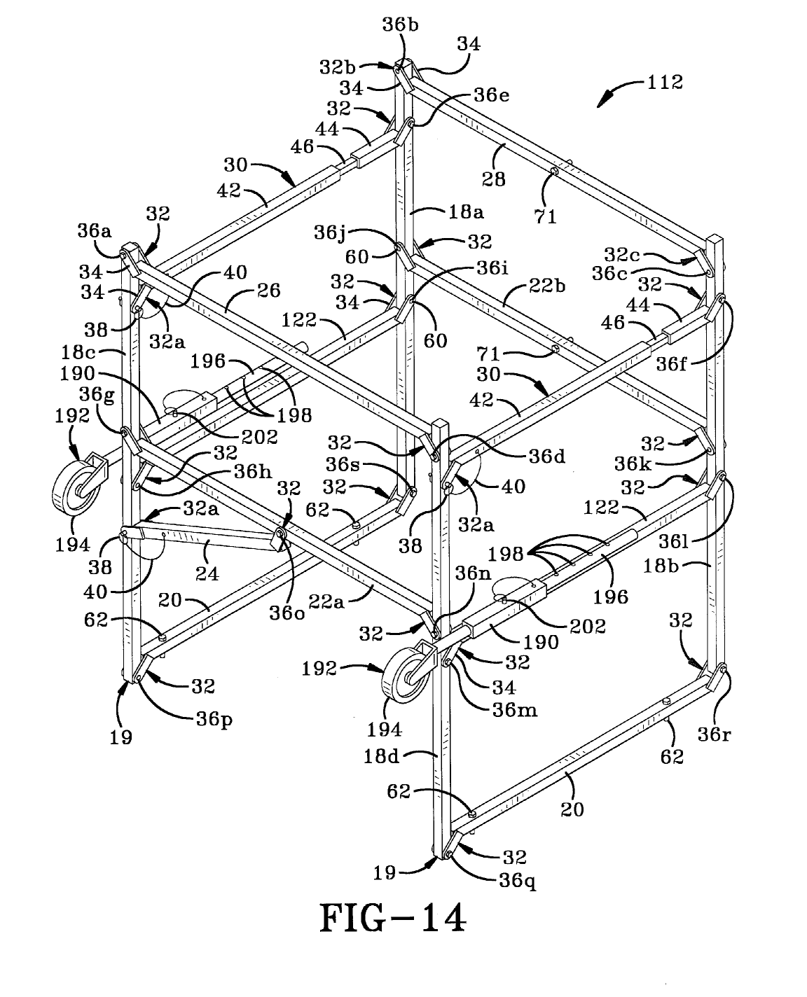

FIG. 14 shows a second embodiment of workbasket assembly in accordance with the present invention and being generally indicated at 112. Workbasket assembly 112 is substantially identical to workbasket assembly 12 except that each mid-rail 122 includes a tube 190 that is welded thereto. A roller bumper 192 is telescopingly received in tube 190. Roller bumper 192 comprises a caster 194 which is attached to a hollow adjustment bar 196. Adjustment bar 196 includes a plurality of holes 198 therein. A cotter pin 202 is selectively insertable through an aperture (not shown) in tube 190 and into any one of the desired holes 198 in adjustment bar 196. Roller bumper 192 can therefore be extended further outwardly away from workbasket assembly 112 to a greater or a lesser degree, or can be withdrawn substantially into tube 190, or can be entirely removed from tube 190. Caster 194 is adapted to engage the interior surface of the side wall of a tank. The caster 194 prevents the workbasket assembly 112 from directly contacting the interior surface of the tank's side wall and because caster 194 is rotatable, it aids in assisting the workbasket to ride up and down within the interior of the tank. It will be understood that tubes 190 and roller bumpers 192 may be secured to any one of the rails or uprights of workbasket assembly 112 without departing from the spirit of the present invention. It will further be understood that workbasket assembly 112 is collapsible and expandable in the same way as workbasket assembly 12.

It will be understood by those skilled in the art that workbasket assembly 12 may be partially collapsed when attached to base 11 but can only be fully collapsed when fully detached from base 11.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A workbasket assembly for detachable engagement with a hoist-operable base, said workbasket assembly comprising:
a frame comprising:
a plurality of vertical uprights;
a plurality of horizontal rails;
a plurality of pivot tabs which pivotally secure the uprights and rails together; whereby the frame surrounds a workman supported on the hoist-operable base; and wherein the frame is movable between an expanded condition and a collapsed condition.

2. The workbasket assembly as defined in claim 1, wherein the workbasket assembly has a height, a width and a length; and when the workbasket assembly is moved from the expanded condition to a partially collapsed condition, the height thereof is reduced, the width remains the same and the length increases.

3. The workbasket assembly as defined in claim 2, wherein the partially collapsed workbasket assembly has a height, a width and a length; and when the workbasket assembly is moved from the partially collapsed condition to a fully collapsed condition, the height thereof remains the same, the width decreases and the length increases.

4. The workbasket assembly as defined in claim 1, wherein each of the rails has a first end and a second end; and a first one of the plurality of pivot tabs extends outwardly from the first end of the rail and engages a first one of the uprights, and a second one of the plurality of pivot tabs extends outwardly from the second end of the rail and engages a second one of the uprights.

5. The workbasket assembly as defined in claim 4, wherein the first pivot tab extends outwardly away from the first end of the rail in a first direction and the second pivot tab extends outwardly away from the second end of the rail in a second direction.

6. The workbasket assembly as defined in claim 5, wherein both of the first and second pivot tabs are inclined at an angle to an outer surface of the rail; and wherein the first and second pivot tabs are substantially parallel to each other.

7. The workbasket assembly as defined in claim 6, wherein the first pivot tab extends beyond the first end of the rail and the second pivot tab extends beyond the second end of the rail; and the first and second pivot tabs substantially permits relative movement between the rail and first and second uprights in a manner that enables the workbasket assembly to collapse.

8. The workbasket assembly as defined in claim 7, whereby the pivot tabs substantially permit relative movement between the rails and the uprights in a manner that enables the workbasket assembly to only collapse in a single direction.

9. The workbasket assembly as defined in claim 1, wherein each of the pivot tabs comprises:
at least one flange which is welded at a first end to one of the plurality of uprights and rails; said flange having an aperture proximate a second end thereof; and
a pivot pin which is engageable through the aperture in the flange to pivotally connect the flange to the other of one of the plurality of uprights and rails.

10. The workbasket assembly as defined in claim 1, wherein at least one of the horizontal rails is a gate rail that is selectively detachable from the associated upright to allow a workman to easily enter into an interior space defined by the frame.

11. The workbasket assembly as defined in claim 10, wherein the gate rail comprises:
a first sleeve that has a longitudinal bore; and
a bar that is slidably receivable within the bore of the first sleeve; and wherein one of the first sleeve and bar is fixedly secured by a first pivot tab to one of the uprights; and the other of the first sleeve and bar is releasably secured by a second pivot tab to another of the uprights.

12. The workbasket assembly as defined in claim 11, further comprising a compression spring that is seated within the bore of the first sleeve and is engageable by an end of the bar received within the bore.

13. The workbasket assembly as defined in claim 12, further comprising a second sleeve defining a second longitudinal bore; and wherein a portion of the bar is received within the bore of the first sleeve and a portion of the bar is received within the bore of the second sleeve.

14. The workbasket assembly as defined in claim 13, wherein the second sleeve is connected to one of the uprights by a second pivot tab, and said second pivot tab comprises:
at least one flange that is welded at a first end to the second sleeve;
at least one aperture defined in the flange; said aperture being selectively alignable with a hole in one of the uprights;
a connector that is selectively receivable in the aligned aperture and hole.

15. The workbasket assembly as defined in claim 1, wherein at least one of the horizontal rails is a bottom rail; and the workbasket assembly further includes a plurality of fasteners that engage the bottom rail and are adapted to secure said bottom rail to the hoist-operable base.

16. The workbasket assembly as defined in claim 1, further comprising a stabilizing bar that is fixedly secured at a first end to one of the uprights and rails, and is detachably secured at a second end to another of the uprights and rails; and wherein said stabilizing bar substantially prevents the movement of the frame from the expanded condition to the collapsed condition when both of the first and second ends thereof are secured, and allows the movement of the frame from the expanded condition to the collapsed condition when only secured at the first end.

17. The workbasket assembly as defined in claim 1, wherein the workbasket assembly in the collapsed condition is able to pass through an opening that is around 8×8 inches in size.

18. The workbasket assembly as defined in claim 1, wherein the frame comprises:
a first, a second, a third and a fourth vertical upright;
a front rail pivotally connected between the first and second uprights;
a back rail pivotally connected between the third and fourth upright;
a first side rail pivotally connected between the first and third uprights; and
a second side rail pivotally connected between the second and fourth uprights.

19. The workbasket assembly as defined in claim 18, further comprising:
a first mid-rail pivotally connected between the first and the second upright;
a second mid-rail pivotally connected between the first and third uprights;
a third mid-rail pivotally connected between the third and fourth uprights and
a fourth mid-rail pivotally connected between the second and fourth uprights.

20. The workbasket assembly as defined in claim 19; further comprising:
a first bottom rail connected between the first and third uprights and
a second bottom rail connected between the second and fourth uprights.

21. The workbasket assembly as defined in claim 19, further comprising a stabilizer bar pivotally connected between one of the mid-rails and one of the uprights.

22. The workbasket assembly as defined in claim 18, the first side rail is detachable from one of the first and third uprights.
